(19) United States
(12) Patent Application Publication
(10) Pub. No.: US 2021/0084909 A1
(43) Pub. Date: Mar. 25, 2021

(54) Materials and Methods for Attracting and Controlling Plant-Pathogenic Nematodes

(71) Applicant: Locus Agriculture IP Company, LLC, Solon, OH (US)

(72) Inventors: Sean FARMER, North Miami Beach, FL (US); Ken ALIBEK, Solon, OH (US); Maja MILOVANOVIC, North Royalton, OH (US)

(21) Appl. No.: 16/971,048

(22) PCT Filed: Feb. 20, 2019
(86) PCT No.: PCT/US2019/018683

§ 371 Date: Aug. 19, 2020

Related U.S. Application Data
(60) Provisional application No. 62/632,660, filed on Feb. 20, 2018.

(51) Int. Cl. A01N 65/08; A01N 65/00; A01N 63/32; A01N 37/06; A01N 63/28

(52) U.S. Cl. CPC A01N 65/08; A01N 65/00; A01N 63/28; A01N 37/06; A01N 63/32

(57) ABSTRACT

The invention provides materials and method for attracting and controlling plant-pathogenic nematodes. In specific embodiments, compositions are provided comprising Valerian root, which draws the nematodes away from plants, and/or a microbe-based composition comprising nematicidal microorganisms and/or their growth by-products, which control the nematodes upon contact. The compositions can be applied to a plants environment, including soil, to attract and control nematodes, and to reduce and/or prevent plant damage caused by nematodes.

### CROSS-REFERENCE TO RELATED APPLICATION

This application claims priority to U.S. Provisional Patent Application No. 62/632,660, filed Feb. 20, 2018, which is incorporated herein by reference in its entirety.

### BACKGROUND OF INVENTION

In order to boost yields and protect crops against pathogens, pests, and disease, farmers have relied heavily on the use of synthetic chemicals and chemical fertilizers; however, when overused or improperly applied, these substances can run off into surface water, leach into groundwater, and evaporate into the air. As sources of air and water pollution, these substances are increasingly scrutinized, making their responsible use an ecological and commercial imperative. Even when properly used, the over-dependence and long-term use of certain chemical fertilizers and pesticides can deleteriously alter soil ecosystems, reduce stress tolerance, increase pest resistance, and impede plant and animal growth and vitality.

Nematodes are known to infect both plants and animals. These microscopic worms can be found in almost every type of environment. When residing in soil, nematodes utilize chemotaxis to locate plant roots to feed on, causing significant damage to the root structure and improper development of plants. The damage is generally manifested by the growth of galls, root knots, and other abnormalities. Gall formation leads to reduced root size and ineffectiveness of the root system, which, in turn, seriously affects other parts of the plant. As a result, the weakened plant becomes vulnerable to attacks by other pathogens. Without proper treatment, the plant dies. Nematodes cause millions of dollars of damage each year to turf grasses, ornamental plants, and food crops.

Nematodes are a class of roundworms or threadworms of the phylum Nematoda. Examples in the class are the cyst forming nematodes of the genus Heterodera (e.g., H. glycines, H avenae, and H. shachtii) and Globodera (e.g., G. rostochiens and G. pallida), the stubby root nematodes of the genus Trichodorus, the bulb and stem nematodes of the genus Ditylenchus, the golden nematode, Heterodera rostochiensis, the root knot nematodes, of the genus Meloidogyne (e.g., M. javanica, M. hapla, M. arenaria and M. incognita), the root lesion nematodes of the genus Pratylenchus (e.g., P. goodeyi, P. penetrans, P. zeae, P. coffeae, P. brachyurus, and P. thornei), the citrus nematodes of the genus Tylenchulus, and the sting nematodes of the genus Belonalaimus.

Root-knot nematodes (Meloidogyne spp.) are one of the three most economically damaging genera of plant-parasitic nematodes on horticultural and field crops. Root-knot nematodes are distributed worldwide, and are obligate parasites of the roots of thousands of plant species, including monocotyledonous and dicotyledonous, herbaceous and woody plants. Vegetable crops grown in warm climates can experience severe losses from root-knot nematodes, and are often routinely treated with a chemical nematicide. Root-knot nematode damage results in poor growth, a decline in quality and yield of the crop and reduced resistance to other stresses (e.g., drought, other diseases). A high level of damage can lead to total crop loss. For example, approximately $1.5 billion per year is lost to soybean cyst nematodes alone.

Conventional nematicides used to control nematodes are applied in the seed furrow at planting. Because of toxicity toward nearby animals, such as birds, overhead center pivots with liquid applications of toxic compounds such as Nemacur, Temik, Furadan, Dazinat and Mocap have all fallen out of favor.

Since the 1960's, methyl bromide has been used by growers to effectively sterilize fields before planting, primarily to control nematodes, as well as to treat disease and weeds; however, because this toxic compound is used in gas form, more than half the amount injected into soil can eventually end up in the atmosphere and contribute to the thinning of the ozone layer. In 2005, developed countries banned methyl bromide under the Montreal Protocol, which is an international treaty signed in 1987 to protect the stratospheric ozone layer.

Under the ban, the treaty allows limited use of methyl bromide in strawberries, almonds, and other crops that lack alternatives for both effective and affordable control of nematodes, disease, and weeds. The extent of authorized use diminishes every year and will likely end soon. Finding alternatives to methyl bromide is, thus, a priority for growers and regulatory agencies; however, no single product provides the wide spectrum of control offered by methyl bromides.

Mounting regulatory mandates governing the availability and use of chemicals, as well as consumer demands for residue free, sustainably-grown food are impacting the industry and causing an evolution of thought regarding how to address the myriad of challenges. While wholesale elimination of chemicals is not feasible at this time, farmers are increasingly embracing the use of biological measures as viable components of Integrated Nutrient Management and Integrated Pest Management programs.

Due to the disadvantages of the major approaches described above, the demand for safer pesticides and alternate pest control strategies is increasing. Particularly, in recent years, biological control of nematodes has attracted great interest. This method utilizes biological agents such as live microbes, bio-products derived from these microbes, and combinations thereof, as pesticides. These biological pesticides have important advantages over other conventional pesticides. For example, they are less harmful compared to the conventional chemical pesticides. Additionally, they are more efficient and specific, and they often biodegrade quickly, leading to less environmental pollution.

The use of biopesticides and other biological agents has been greatly limited by difficulties in production, transportation, administration, pricing and efficacy. For example, many microbes are difficult to grow and subsequently deploy to agricultural and forestry production systems in sufficient quantities to be useful. This problem is exacerbated by loses in viability and/or activity due to processing, formulating, storage, stabilizing prior to distribution, sporulation of vegetative cells as a means of stabilizing, transportation, and application. Furthermore, once applied, biological products may not thrive for any number of reasons including, for example, insufficient initial cell densities, the inability to compete effectively with the existing microflora at a particular location, and being introduced to soil and/or other environmental conditions in which the microbe cannot flourish or even survive.

Therefore, there is an urgent need for development of improved, environmentally-friendly methods and materials for controlling nematodes.

### BRIEF SUMMARY OF THE INVENTION

The subject invention provides compositions and methods for attracting and controlling nematodes. In addition, the subject methods and compositions can be used for preventing damage to crops due to nematode infection, thus resulting in yield increases. Advantageously, the subject invention utilizes non-toxic substances, such as, for example, beneficial microbes and by-products of microbial cultivation.

In one embodiment, the subject invention provides a nematicidal composition for attracting, and subsequently controlling, nematodes in soil. In certain embodiments, the composition comprises a chemo-attractant substance and a nematicidally-effective amount of a microbe-based composition comprising one or more beneficial microorganisms and/or growth by-products thereof, wherein the microbe-based composition is capable of nematicidal action.

The nematicidal composition may be used to protect plants, humans, or animals by attracting and controlling nematode pests. Advantageously, the composition is non-toxic to humans.

In preferred embodiments, the composition comprises Valerian (Valeriana officinalis) as a powerful nematode attractant. In certain embodiments, Valerian root can be cut into small pieces and added to the composition. In some embodiments, Valerian root extract, or Valerian root powder is included in the composition. Powders, extracts and other forms of other Valerian plant parts are also envisioned for inclusion in the composition.

In certain embodiments, the composition can comprise live cells and/or mycelia of the filamentous fungus Pleurotus ostreatus, and/or a growth by-product thereof. In one embodiment, the growth by-product is a substance that is toxic to nematodes. In one specific embodiment, the nematode-toxic growth by-product of P. ostreatus is peroxide of linoleic acid.

In one embodiment, the composition can comprise a bacterium capable of producing the anti-nematodal growth by-product, avermectin (e.g., Streptomyces avermitilis). In one embodiment, the composition comprises avermectin without the microbe that produced it.

In one embodiment, the composition can comprise a yeast capable of producing an anti-nematodal glycolipid biosurfactant. For example, in one embodiment, the composition can comprise a microbe capable of producing a type of anti-nematodal glycolipid known as mannosylerythritol lipids (MEL) (e.g., Pseudozyma aphidis or Meyerozyma guilliermondii). In one embodiment, the composition comprises a MEL without the microbe that produced it.

The microbes and/or microbe growth by-products of the nematicidal composition can be obtained through cultivation processes ranging from small to large scale. These cultivation processes include, but are not limited to, submerged cultivation/fermentation, solid state fermentation (SSF), and combinations thereof. The nematicidal composition may comprise, for example, microbes, the broth resulting from fermentation and/or purified growth by-products.

In one embodiment, an anti-nematodal microbial growth by-product is added in the form of an unpurified supernatant resulting from cultivation of a microorganism. In another embodiment, the growth by-product can be extracted from the supernatant and, optionally, purified, prior to inclusion in the subject composition. The growth by-product can comprise, for example, linoleic acid, avermectin and/or MEL.

In one embodiment, the subject invention provides methods for controlling nematodes present on a plant and/or in a plant's surrounding environment, as well as for preventing damage to plants and/or crops caused by nematodes, wherein the methods comprise the steps of: applying a chemo-attractant substance to a locus, wherein the locus is within the plant's surrounding environment but located at a distance of, for example, 1 inch to 60 inches, or more, away from the plant.

In certain embodiments, the method further comprises applying a microbe-based composition comprising one or more beneficial microorganisms and/or anti-nematodal growth by-products thereof, to the locus.

The locus of application can be a distance of, for example, 1 to 60 inches, or more, away from the nearest plant, about 5 to 50 inches away, or about 10 to 25 inches away. When, for example, the plant is part of a group of plants, such as a crop or garden, multiple loci of application can be employed, for example, evenly spaced between rows of plants or between individual plants. The locus could also be at the periphery of a plot or field where plants are growing. In certain preferred embodiments, the chemo-attractant and/or microbe-based composition are applied in, or directly on top of, soil.

Advantageously, the method rapidly draws plant-pathogenic nematodes away from plants and controls them upon contact therewith. In some embodiments, the composition controls, e.g., kills, the nematode quickly upon contact.

In one embodiment, the method comprises applying the one or more beneficial microorganisms and/or their anti-nematodal growth by-products, without the chemo-attractant, to a plant or plant part. Thus, in situations where nematodes and/or nematode eggs are present on a plant, the nematodes and/or hatched juveniles will be controlled before causing significant damage to the plant.

The compositions of the subject invention can be applied, for example, through an irrigation system, to the soil surface, and/or to pest surfaces. Mechanical application through conventional hand tools, robotic application, and/or application through aerial or ground based “drones” is also facilitated. Furthermore, in one embodiment, the composition can be placed into a ground spike or bait station, which is placed into soil at the locus of application.

### BRIEF DESCRIPTION OF DRAWINGS

FIG. 1 shows a plot set-up for evaluation of nematode attractant efficacy, including locations of nematode inoculation zone and attractant application zone.

FIG. 2 shows percent infestation (of total plot nematode population) at three different locations in plots for nematode attractant evaluation. “Center” refers to center of inoculation zone, “attractant” refers to the attractant zone, and “untreated” refers to all other plot areas.

### DETAILED DISCLOSURE

The subject invention provides compositions and methods for attracting and controlling nematodes. In addition, the subject methods and compositions can be used for preventing damage to crops due to nematode infection, thus resulting in yield increases. Advantageously, the subject invention utilizes non-toxic substances, such as, for example, beneficial microbes and by-products of microbial cultivation.

In one embodiment, the subject invention provides a nematicidal composition for attracting, and subsequently controlling, nematodes in soil. In certain embodiments, the composition comprises a chemo-attractant substance and a nematicidally-effective amount of one or more beneficial microorganisms and/or growth by-products thereof, wherein the beneficial microorganisms and/or growth by-products thereof are capable of nematicidal action.

In one embodiment, the compositions can be applied to soil or another locus at some distance away from plants, thus providing for methods of controlling nematodes, as well as for preventing damage to plants and/or crops caused by nematodes.

### Selected Definitions

As used herein, reference to a “microbe-based composition” means a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. In some embodiments, the microbes are present, with medium in which they were grown, in the microbe-based composition. The cells may be present at, for example, a concentration of 1×10⁴, 1×10⁵, 1×10⁶, 1×10⁷, 1×10⁸, 1×10⁹, 1×10¹⁰, 1×10¹¹, 1×10¹² or 1×10¹³ or more CFU per milliliter of the composition.

The subject invention further provides “microbe-based products,” which are products that are to be applied in practice to achieve a desired result. The microbe-based product can be simply the microbe-based composition harvested from the microbe cultivation process, or individual components thereof, such as supernatant. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, “harvested” in the context of fermentation processes refers to removing some or all of the microbe-based composition from a growth vessel.

As used herein, a “biofilm” is a complex aggregate of microorganisms, wherein the cells adhere to each other. In some embodiments, biofilms can adhere to surfaces. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule, is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An “isolated” microbial strain means that the strain is removed from the environment in which it exists in nature. Thus, the isolated strain may exist as, for example, a biologically pure culture, or as spores (or other forms of the strain) in association with a carrier.

As used here in, a “biologically pure culture” is one that has been isolated from materials with which it is associated in nature. In a preferred embodiment, the culture has been isolated from all other living cells. In further preferred embodiments, the biologically pure culture has advantages characteristics compared to a culture of the same microbe as it exists in nature. The advantageous characteristics can be, for example, enhanced probation of one or more by-products of their growth.

In certain embodiments, purified compounds are at least 60% by weight (dry weight) the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. A metabolite can be an organic compound that is a starting material (e.g., glucose), an intermediate (e.g., acetyl-CoA) in, or an end product (e.g., n-butanol) of metabolism. Examples of metabolites include, but are not limited to, biopolymers, enzymes, acids, solvents, alcohols, proteins, vitamins, minerals, microelements, amino acids, carbohydrates and biosurfactants.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “non-pathogenic” means incapable of causing disease to an organism.

As used herein, “prevention” means avoiding, delaying, forestalling, or minimizing the onset or progression of a particular situation or occurrence. Prevention can include, but does not require, absolute or complete prevention, meaning the situation or occurrence may still develop, but at a later time than it would without preventative measures. Prevention can include reducing the severity of the onset of a situation or occurrence, and/or inhibiting the progression of the situation or occurrence to a more severe situation or occurrence.

As used herein, “reduce” refers to a negative alteration, and the term “increase” refers to a positive alteration, of at least (positive or negative) 1%, 5%, 10%, 25%, 50%, 75%, or 100%.

As used herein, “reference” refers to a standard or control condition.

As used herein, “surfactant” refers to a compound that lowers the surface tension (or interfacial tension) between two liquids or between a liquid and a solid. Surfactants act as, e.g., detergents, wetting agents, emulsifiers, foaming agents, and dispersants. A “biosurfactant” is a surfactant produced by a living organism.

As used herein, “agriculture” means the cultivation and breeding of plants, algae and/or fungi for food, fiber, biofuel, medicines, cosmetics, supplements, ornamental purposes and other uses. According to the subject invention, agriculture can also include horticulture, landscaping, gardening, plant conservation, orcharding and arboriculture. Further included in agriculture is the care, monitoring and maintenance of soil.

As used herein, a “pest” is any organism, other than a human, that is destructive, deleterious and/or detrimental to humans or human concerns (e.g., agriculture, horticulture, livestock care, aquaculture). Pests may cause and/or carry infections, infestations and/or disease. Pests can cause direct harm to, for example, plants, by ingesting plant parts. Pests may be single- or multi-cellular organisms, including but not limited to, viruses, fungi, bacteria, parasites, arthropods and/or nematodes.

As used herein, the term “control” used in reference to a pest means killing, disabling, immobilizing, eradicating or reducing population numbers of a pest, or otherwise rendering the pest substantially incapable of causing harm.

As used herein “nematicidal” and “anti-nematodal” mean having the ability to control nematodes. Thus, for example, killing nematodes, reducing their motility, and reducing egg counts are all examples of nematicidal/anti-nematodal activity. Accordingly, a “nematicidally-effective” amount of a substance is an amount that is capable of nematicidal/anti-nematodal action.

As used herein, a plant's “surrounding environment” means the soil and/or other medium in which the plant is growing, which can include the rhizosphere. In certain embodiments, the surrounding environment does not extend past, for example, a radius of 100 feet, 10 feet, 8 feet, or 6 feet from the plant.

The description herein of any aspect or embodiment of the invention using terms such as “comprising,” “having,” “including” or “containing” with reference to an element or elements is intended to provide support for a similar aspect or embodiment of the invention that “consists of,” “consists essentially of,” or “substantially comprises” that particular element or elements, unless otherwise stated or clearly contradicted by context.

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references referred to or cited herein are incorporated by reference in their entirety, including all figures and tables, to the extent they are not inconsistent with the explicit teachings of this specification.

### Nematicidal Compositions

The subject invention provides compositions and methods for attracting and controlling nematodes. In addition, the subject methods and compositions can be used for preventing damage to crops due to nematode infection, thus resulting in yield increases. Advantageously, the subject invention utilizes non-toxic substances, such as, for example, beneficial microbes and by-products of microbial cultivation.

In one embodiment, the subject invention provides a nematicidal composition for attracting, and subsequently controlling, nematodes in soil. In certain embodiments, the composition comprises a chemo-attractant substance. In certain embodiments, the composition comprises a nematicidally-effective amount of a microbe-based composition comprising one or more beneficial microorganisms and/or growth by-products thereof, wherein the microbe-based composition is capable of nematicidal action.

In preferred embodiments, the composition comprises both the chemo-attractant substance and the microbe-based composition.

In one embodiment, the composition comprises Valerian (Valeriana spp., e.g., V. officinalis) as a powerful nematode chemo-attractant. In certain embodiments, Valerian root can be cut into small pieces and added to the composition. In some embodiments, Valerian root extract, or Valerian root powder is included in the composition. Any other compound or by-product associated with the Valerian plant can also be used as an attractant according to the subject compositions and methods, in the form of powders, extracts or other forms, such as valerenic acid. Other acceptable attracting substances, such as soluble and gaseous substances produced by the roots of host plants or by attendant rhizosphere microorganisms can also be used.

In one embodiment, the composition comprises Valerian root extract at a concentration of 0.1% to 5.0%, 0.3% to 4.0% or 0.5% to 2.0%.

In certain embodiments, the composition can comprise a microbe-based composition comprising one or more beneficial microorganisms and/or their growth by-products.

In one embodiment, the composition comprises live cells and/or mycelia of the filamentous fungus Pleurotus ostreatus, and/or a growth by-product thereof. In one embodiment, the growth by-product is a substance that is toxic to nematodes. In one specific embodiment, the nematode-toxic growth by-product of P. ostreatus is peroxide of linoleic acid.

In one embodiment, the composition can comprise a bacterium capable of producing the anti-nematodal growth by-product, avermectin (e.g., Streptomyces avermitilis). In one embodiment, the composition comprises avermectin without the microbe that produced it.

In one embodiment, the composition comprises purified avermectin at concentrations of 0.01 to 90% by weight, 0.1 to 50%, or 0.1 to 20%. In another embodiment, purified MEL may be in combination with an accepted carrier, in that avermectin may be presented at concentrations of 0.01 μg/ml to 50 μg/ml, 0.1 μg/ml to 25 μg/ml, or 0.5 μg/ml to 15 μg/ml.

In one embodiment, the composition can comprise a yeast capable of producing an anti-nematodal glycolipid biosurfactant. For example, in one embodiment, the composition can comprise a microbe capable of producing a type of anti-nematodal glycolipid known as mannosylerythritol lipids (MEL). In one embodiment, the MEL-producing microbe can be Pseudozyma spp. (e.g., P. aphidis), Candida spp., Ustilago spp., Schizonella spp., Kurtzmanomyces spp. and/or Meyerozyma guilliermondii (also known as Pichia guilliermondii). In one embodiment, the composition comprises a MEL without the microbe that produced it.

In one embodiment, the composition comprises purified MEL at concentrations of 0.01 to 90% by weight, 0.1 to 50%, or 0.1 to 20%. In another embodiment, purified MEL may be in combination with an accepted carrier, in that MEL may be presented at concentrations of 0.001 to 50% (v/v), 0.01 to 20% (v/v), or 0.02 to 5% (v/v).

The microorganisms useful according to the subject invention can be, for example, non-plant-pathogenic strains of bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

The microbes and/or microbe growth by-products of the nematicidal composition can be obtained through cultivation processes ranging from small to large scale. These cultivation processes include, but are not limited to, submerged cultivation/fermentation, solid state fermentation (SSF), and combinations thereof. The nematicidal composition may comprise, for example, microbes, the broth resulting from fermentation and/or purified growth by-products.

In one embodiment, an anti-nematodal microbial growth by-product is added in the form of an unpurified supernatant resulting from cultivation of a microorganism. In another embodiment, the growth by-product can be extracted from the supernatant and, optionally, purified, prior to inclusion in the subject composition. The growth by-product can be, for example, linoleic acid, avermectin and/or MEL.

The microbes and/or growth medium (including discrete layers or fractions) resulting from the microbial growth can be removed from the growth vessel in which they were produced and transferred via, for example, piping for immediate use.

The microorganisms in the microbe-based product may be in an active or inactive form, in cell form, spore form, and/or mycelial form. The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

In one embodiment, the cultivation products may be prepared as a spray-dried biomass product. The biomass may be separated by known methods, such as centrifugation, filtration, separation, decanting, a combination of separation and decanting, ultrafiltration or microfiltration. The biomass product may be separated from the cultivation medium, and spray-dried.

The microbe-based products may be formulated in a variety of ways, including liquid, solids, granular, dust, or slow release products by means that will be understood by those of skill in the art having the benefit of the instant disclosure.

Solid formulations of the invention may have different forms and shapes such as cylinders, rods, blocks, capsules, tablets, pills, pellets, strips, spikes, etc. Solid formulations may also be milled, granulated or powdered. The granulated or powdered material may be pressed into tablets or used to fill pre-manufactured gelatin capsules or shells. Semi solid formulations can be prepared in paste, wax, gel, or cream preparations.

The solid or semi-solid compositions of the invention can be coated using film-coating compounds used in the pharmaceutical industry such as polyethylene glycol, gelatin, sorbitol, gum, sugar or polyvinyl alcohol. This is particularly essential for tablets or capsules used in pesticide formulations. Film coating can protect the handler from coming in direct contact with the active ingredient in the formulations. In addition, a bittering agent such as denatonium benzoate or quassin may also be incorporated in the pesticidal formulations, the coating or both.

The compositions of the invention can also be prepared in powder formulations and filled into pre-manufactured gelatin capsules.

The concentrations of the ingredients in the formulations and application rate of the compositions may be varied widely depending on the pest, plant or area treated, or method of application.

### Methods for Culturing the Microbes

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic.

In one embodiment, the subject invention provides materials and methods for the production of biomass (e.g., viable cellular material), extracellular metabolites (e.g. small molecules and excreted proteins), residual nutrients and/or intracellular components (e.g. enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination. Additionally, antifoaming agents may also be added to prevent the formation and/or accumulation of foam when gas is produced during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

Advantageously, in accordance with the subject invention, the microbe-based product may comprise medium in which the microbes were grown. The product may be, for example, at least, by weight, 1%, 5%, 10%, 25%, 50%, 75%, or 100% growth medium. The amount of biomass in the product, by weight, may be, for example, anywhere from 0% to 100% inclusive of all percentages therebetween.

In certain embodiments, the biomass content may be, for example, from 5 g/l to 180 g/l or more, or from 10 g/I to 150 g/1. Cell concentration may be, for example, 1×10⁹, 1×10¹⁰, 1×10¹¹, 1×10¹² or 1×10¹³ CFU per gram of final product.

The microbial growth by-product produced by microorganisms of interest may be retained in the microorganisms or secreted into the growth medium. The medium may contain compounds that stabilize the activity of microbial growth by-product.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

In one embodiment, the microbes are cultivated within 100, 50, 25, 10, 5, 1, or less miles of where the microbe-based product will be used. In other embodiments, the microbes, supernatant and/or microbial growth by-products can be placed in containers of appropriate size, taking into consideration, for example, the intended use, the contemplated method of application, the size of the fermentation tank, and any mode of transportation from microbe growth facility to the location of use. Thus, the containers into which the microbe-based composition is placed may be, for example, up to 1 gallon, 2 gallons, 5 gallons, 25 gallons, to 1,000 gallons or more.

Advantageously, the method does not require complicated equipment or high energy consumption. The microorganisms of interest can be cultivated at small or large scale on site and utilized, even being still-mixed with their media.

Advantageously, the microbe-based products can be produced in remote locations. The microbe growth facilities may operate off the grid by utilizing, for example, solar, wind and/or hydroelectric power.

### Preparation of Microbe-Based Products

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, the different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers and/or piped (or otherwise transported for use). Example of such additives include carriers, adjuvants, fillers, plasticizers, lubricants, glidants, colorants, pigments, bittering agents, buffering agents, solubility controlling agents, pH adjusting agents, preservatives, other microbe-based compositions produced at the same or different facility, viscosity modifiers, nutrients for microbe growth, nutrients for plant growth, surfactants, emulsifying agents, tracking agents, pesticides, herbicides, solvents, biocides, antibiotics, stabilizers, ultra-violet light resistant agents, and other suitable additives that are customarily used for such preparations.

Stiffening or hardening agents may also be incorporated to strengthen the formulations and make them strong enough to resist pressure or force in certain applications such as soil, root flare or tree injection tablets.

In one embodiment, the composition may further comprise buffering agents including, for example, organic and amino acids or their salts. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts.

In one embodiment, the composition may further comprise pH adjusting agents, including, for example, potassium hydroxide, ammonium hydroxide, potassium carbonate or bicarbonate, hydrochloric acid, nitric acid, sulfuric acid or a mixture.

In one embodiment, additional components, such as sodium bicarbonate or carbonate, sodium sulfate, sodium phosphate, sodium biphosphate, can be included in the formulation

The composition may further be combined with other acceptable active or inactive components. These components can be, for example, an oil component such as cinnamon oil, clove oil, cottonseed oil, garlic oil, or rosemary oil; another natural surfactant such as Yucca or Quillaja saponins; or the component may be an aldehyde such as cinnamic aldehyde. Other oils that may be used as a pesticidal component or adjuvants include: almond oil, camphor oil, canola oil, castor oil, cedar oil, citronella oil, citrus oil, coconut oil, corn oil, eucalyptus oil, fish oil, geranium oil, lecithin, lemon grass oil, linseed oil, mineral oil, mint or peppermint oil, olive oil, pine oil, rapeseed oil, safflower oil, sage oils, sesame seed oil, sweet orange oil, thyme oil, vegetable oil, and wintergreen oil.

In one embodiment, the compositions can include one or more chemical compounds with nematicidal activity. These include carbamate nematicides such as benomyl, carbofuran, carbosulfan, and cleothocard; oxime carbamate nematicides such as alanycarb, aldicarb, aldoxycarb, oxamyl; organophosphorous nematicides such as diamidafos, fenamiphos, fosthietan, phosphamidon, cadusafos, chlorpyrifos, dichlofenthion, dimethoate, ethoprophos, fensulfothion, fosthiazate, heterophos, isamidofos, isazofos, methomyl, phorate, phosphocarb, terbufos, thiodicarb, thionazin, triazophos, imicyafos, and mecarphon. Other compounds with nematicidal activity include acetoprole, benclothiaz, chloropicrin, dazomet, DB CP, DCIP, 1,2-dichloropropane, 1,3-dichloropropene, furfural, iodomethane, metam, methyl bromide, methyl isothiocyanate, and xylenols.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a citrus grove). For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This allows for a scaled-down bioreactor (e.g., smaller fermentation vessel, smaller supplies of starter material, nutrients and pH control agents), which makes the system efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

In one embodiment, the microbe growth facility is located on, or near, a site where the microbe-based products will be used (e.g., a citrus grove), for example, within 300 miles, 200 miles, or even within 100 miles. Advantageously, this allows for the compositions to be tailored for use at a specified location. The formula and potency of microbe-based compositions can be customized for specific local conditions at the time of application, such as, for example, which soil type, plant and/or crop is being treated; what season, climate and/or time of year it is when a composition is being applied; and what mode and/or rate of application is being utilized.

Advantageously, distributed microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

Furthermore, by producing a composition locally, the formulation and potency can be adjusted in real time to a specific location and the conditions present at the time of application. This provides advantages over compositions that are pre-made in a central location and have, for example, set ratios and formulations that may not be optimal for a given location.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products.

The cultivation time for the individual vessels may be, for example, from 1 to 7 days or longer. The cultivation product can be harvested in any of a number of different ways.

Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### Methods of Controlling Nematodes

In one embodiment, the subject invention provides methods for controlling nematodes present on a plant and/or in a plant's surrounding environment, as well as for preventing damage to plants and/or crops caused by nematodes, wherein the methods comprise the steps of: applying a nematicidal composition of the subject invention to a locus, wherein the locus is within the plant's surrounding environment but located at a distance of, for example, at least 1 inch to 60 inches, or more, away from the plant.

In certain embodiments, the nematicidal composition comprises a chemo-attractant substance, such as, e.g., Valerian root extract. In certain embodiments, the nematicidal composition comprises one or more beneficial microorganisms and/or anti-nematodal growth by-products thereof, e.g., a microbe-based composition as described elsewhere in the subject description.

In some embodiments, the one or more beneficial microorganisms are P. ostreatus, S. avermitilis, P. aphidis, and/or M. guilliermondii. In some embodiments, the anti-nematodal growth by-products comprise purified and/or unpurified linoleic acid, avermectin, and/or a nematicidal glycolipid (e.g., MEL).

In one embodiment, the method comprises applying both the chemo-attractant substance and the microbe-based composition as a single application. In another embodiment, the method comprises applying the chemo-attractant substance and the microbe-based composition separately, for example, individually or sequentially.

In certain preferred embodiments, the chemo-attractant and/or microbe-based composition are applied in, or directly on top of, soil.

The locus of application can be a distance of, for example, 1 to 60 inches, or more, away from the nearest plant, about 5 to 50 inches away, or about 10 to 25 inches away. When, for example, the plant is part of a plurality (i.e., more than one) of plants, such as a crop or garden, multiple loci of application can be employed, for example, evenly spaced between rows of plants or between individual plants. Preferably, each of the multiple loci are located at a distance of 1 inch to 60 inches, or more, away from each of the plants in the plurality. The locus or loci could also be at the periphery of a plot or field where plants are growing.

Advantageously, the method rapidly draws plant-pathogenic nematodes away from plants and controls them upon contact therewith. In some embodiments, the composition controls, e.g., kills, the nematode quickly upon contact.

In one embodiment, substances that enhance the growth of beneficial microorganisms and the production of nematicidal microbial growth by-products may also be added to the composition and/or the treatment site. These substances include, but are not limited to, carbon, or organic substrates such as oil, glycerol, sugar, or other nutrients.

Carbon substrates can include, but are not limited to, organic carbon sources such as natural or synthetic oil including used frying oil; fat; lipid; wax (natural or paraffin); fatty acids such as lauric; myristic, etc.; fatty acid alcohol such as lauryl alcohol; amphiphilic esters of fatty acids with glycerol such as glyceryl monolaurate; glycol esters of fatty acid such as polyethylene monostearate; fatty acid amines such as lauryl amine; fatty acid amides; hexanes; glycerol; glucose; etc. When biosurfactant production is desired, it is preferable to use a water insoluble carbon substrate.

In one embodiment, the composition can be added to the soil, plants' growing medium, plants, aquatic medium, or any area to be treated to prevent pest damage. The beneficial microorganisms can grow in situ to produce nematicidal growth by-products and control nematodes.

In one embodiment, the composition may be applied by spraying, pouring, dipping, in the form of concentrated or diluted liquids, solutions, suspensions, powders, and the like, containing such concentrations of the active agent(s) as is most suited for a particular purpose at hand. They may be applied as is or reconstituted prior to use.

In one embodiment, the composition according to the subject invention maybe applied at about 0.0001 pounds/acre to about 10 pounds/acre, about 0.001 pounds/acre to about 5 pounds/acre, about 0.01 pounds/acre to about 1 pounds/acre, about 0.01 pounds/acre to about 0.1 pounds/acre, or about 0.01 pounds/acre to about 0.05 pounds/acre.

In one embodiment, the composition according to the subject invention is applied to the environment of a plant from about 1 to about 100 days, about 2 to about 50 days, about 10 to about 40 days, about 20 to about 30 days after the initial application to soil or seed.

In specific embodiments, the compositions may be, for example, introduced into an irrigation system, sprayed from a backpack or similar handheld devices, applied by a land based or airborne robotic device such as a drone, and/or applied with a seed. Additionally, in one embodiment, the composition can be placed into a ground spike or bait station, such as those used for baiting termites, which is placed into soil at the locus of application. Furthermore, the composition may be applied by direct injection into soil or root flares.

In certain embodiments, the compositions provided herein are applied to the soil surface without mechanical incorporation. The beneficial effect of the soil application can be activated by rainfall, sprinkler, flood, or drip irrigation.

The composition may also be applied so as to promote beneficial colonization of the roots and/or rhizosphere as well as the vascular system of the plant in order to promote plant health and vitality. Thus, nutrient-fixing growth of microbes such as Rhizobium and/or Mycorrhizaer can be promoted, as well as other endogenous or exogenous, microbes that combat pests, or disease, or otherwise promote crop growth, health and/or yield.

In one specific embodiment, the method comprises applying the one or more beneficial microorganisms and/or one or more anti-nematodal growth by-products, without the chemo-attractant, to a plant or plant part. Thus, the methods can be used for control of nematodes that are already present on the plant, as well as to prevent damage to the plant by nematodes that are present and/or may arrive after the plant is treated with the composition (e.g., nematodes that emerge from eggs that are present).

In one embodiment, the composition can be applied to a germinated and/or growing plant, including roots, stems, and leaves. The composition may also be applied as a seed treatment. The use as a seed treatment is beneficial because the application can be achieved easily, and the amount used for treatment may be reduced, further reducing the potential toxicity, if any.

Seed application may be by, for example, a seed coating or by applying the composition to the soil contemporaneously with the planting of seeds. This may be automated by, for example, providing a device or an irrigation system that applies the microbe-based composition along with, and/or adjacent to, seeds at, or near, the time of planting the seeds. Thus, the microbe-based composition can be applied within, for example, 5, 4, 3, 2, or 1 day before or after the time of plantings or simultaneously with planting of the seeds.

In one embodiment, the subject invention provides a method of improving plant health and/or increasing crop yield by applying a composition disclosed herein to soil, seed, or plant parts. In another embodiment, the subject invention provides a method of increasing crop or plant yield comprising multiple applications of a composition described herein.

In certain embodiments, the methods and compositions according to the subject invention reduce damage to a plant caused by nematodes by about 5%, 10%, 20%, 30%, 40%, 50%, 60% 70%, 80%, or 90% or more, compared to plants growing in an untreated environment.

In certain embodiments, the methods and compositions according to the subject invention lead to an increase in crop yield by about 5%, 10%, 20%, 30%, 40%, 50%, 60% 70%, 80%, or 90% or more, compared to untreated crops.

In one embodiment, the methods of the subject invention lead to a reduction in the number of nematode eggs in the roots of a plant by about 5%, 10%, 20%, 30%, 40%, 50%, 60% 70%, 80%, or 90% or more, compared to a plant growing in an untreated environment.

In one embodiment, the methods of the subject invention lead to an increase in the mass of a plant by about 5%, 10%, 20%, 30%, 40%, 50%, 60% 70%, 80%, or 90% or more, compared to a plant growing in an untreated environment.

### Target Pests

In preferred, but non-limiting, embodiments of the invention the nematode controlled is chosen from:

(1) a nematode that is a plant pathogenic nematode, such as but not limited to: Root Knot Nematodes (Meloidogyne spp.) in rice (e.g., M. incognita, M. javanica or M. graminicola), in soybean (e.g., M. incognita or M. arenaria), in cotton (e.g., M. incognita), in potato (e.g., M. chitwoodi or M. hapla), in tomato (e.g., M. chitwoodi), in tobacco (e.g., M. incognita, M. javanica or M. arenaria), and in corn (e.g., M. incognita); Cyst Nematodes (Heterodera spp.) in rice (e.g., H. oryzae), in soybean (e.g., H. glycines) and in corn (e.g., H. zeae); Cyst nematodes (Globodera spp.) in potato (e.g., G. pallida or G. rostochiensis); Reniform Nematodes (Rotylenchulus spp.) in cotton (e.g., R. reniformis); Root lesion nematodes (Pratylenchus spp.) in banana (e.g., P. coffeae or P. goodeyi); Burrowing Nematodes (Radopholus spp.) in banana (e.g., R. similis); and other rice damaging nematodes such as rice root nematode (Hirschmaniella spp., e.g. H. oryzae);

(2) a nematode capable of infesting humans such as, but not limited to: Enterobius vermicularis, the pinworm that causes enterobiasis; Ascaris lumbridoides, the large intestinal roundworm that causes ascariasis; Necator and Ancylostoma, two types of hookworms that cause ancylostomiasis; Trichuris trichiura, the whipworm that causes trichuriasis; Strongyloides stercoralis that causes strongyloidiasis; and Trichonella spirae that causes trichinosis; Brugia malayi and Wuchereria bancrofti, the filarial nematodes associated with the worm infections known as lymphatic filariasis and its gross manifestation, elephantiasis, and Onchocerca volvulus that causes river blindness;

(3) a nematode capable of infesting animals such as, but not limited to: dogs (Hookworms e.g., Ancylostoma caninum or Uncinaria stenocephala, Ascarids e.g., Toxocara canis or Toxascaris leonina, or Whipworms e.g., Trichuris vulpis), cats (Hookworms e.g., Ancylostoma tubaeforme, Ascarids e.g., Toxocara cati), fish (herring worms or cod worms e.g., Anisakid, or tapeworm e.g., Diphyllobothrium), sheep (Wire worms e.g., Haemonchus contortus) and cattle (Gastro-intestinal worms e.g., Ostertagia ostertagi, Cooperia oncophora);

(4) a nematode that causes unwanted damage to substrates or materials, such as nematodes that attack foodstuffs, seeds, wood, paint, plastic, clothing etc. Examples of such nematodes include, but are not limited to: Meloidogyne spp. (e.g., M. incognita, M. javanica, M. arenaria, M. graminicola, M. chitwoodi or M. hapla); Heterodera spp. (e.g., H. oryzae, H. glycines, H. zeae or H. schachtii); Globodera spp. (e.g., G. pallida or G. rostochiensis); Ditylenchus spp. (e.g., D. dipsaci, D. destructor or D. angustus); Belonolaimus spp.; Rotylenchulus spp. (e.g., R. reniformis); Pratylenchus spp. (e.g., P. coffeae, P. goodeyi or P. zeae); Radopholus spp. (e.g., R. Similis); Hirschmaniella spp. (e.g., H. oryzae); Aphelenchoides spp. (e.g., A. besseyi); Criconemoides spp.; Longidorus spp.; Helicotylenchus spp.; Hoplolaimus spp.; Xiphinema spp.; Paratrichodorus spp. (e.g., P. minor); Tylenchorhynchus spp;

(5) virus transmitting nematodes (e.g. Longidorus macrosoma: transmits prunus necrotic ring spot virus, Xiphinema americanum: transmits tobacco ring spot virus, Paratrichadorus teres: transmits pea early browning virus, or Trichodorus similis: transmits tobacco rattle virus).

Specific nematode pests include:

Dracunculus medinensis, the roundworm that causes Dracunculiasis (Guinea worm disease); nematodes Loa loa (the African eye worm), Mansonella streptocerca and Onchocerca volvulus, which cause Cutaneous Filariasis; Mansonella perstans and Mansonella ozzardi, which cause Body Cavity Filariasis; Trichinella, including T. pseudospiralis (infecting mammals and birds worldwide), T. nativa (infecting Arctic bears), T. nelsoni (infecting African predators and scavengers), and T. britovi (infecting carnivores of Europe and western Asia), which cause Trichinellosis; Angiostrongylus cantonensis (the rat lungworm), which is the most common cause of human eosinophilic meningitis; Angiostrongylus costaricensis, which causes abdominal (or intestinal) angiostrongyliasis; Toxocara, which causes human toxocariasis; Gnathostoma spinigerum, and rarely G. hispidum, which cause Gnathostomiasis; and Anisakis simplex, or Pseudoterranova decipiens, which causes Anisakiasis.

In specific embodiments, the methods and compositions of the subject invention are used to control root-knot nematode (Meloidogyne incognital), sting nematode (Belonolaimus longicaudatus), soybean cyst nematode (Heterodera glycines), lesion nematode (Pratylenchus sp.), dagger nematode (Xiphinema sp.), and/or citrus nematode (Tylenchulus semipenetrans).

### Target Plants

As used here, the term “plant” includes, but is not limited to, any species of woody, ornamental or decorative, crop or cereal, fruit plant or vegetable plant, flower or tree, macroalga or microalga, phytoplankton and photosynthetic algae (e.g., green algae Chlamydomonas reinhardtii). “Plant” also includes a unicellular plant (e.g. microalga) and a plurality of plant cells that are largely differentiated into a colony (e.g. volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop or pasture.

Example of plants for which the subject invention is useful include, but are not limited to, cereals and grasses (e.g., wheat, barley, rye, oats, rice, maize, sorghum, corn), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

Types of plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), citrus crops (e.g., orange, lemon, grapefruit, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), managed pastures (any mix of plants used to support grazing animals).

Further plants that can benefit from the products and methods of the invention include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., A. sativa, A. fatua, A. byzantina, A. fatua var. sativa, A. hybrida), Averrhoa carambola, Bambusa sp., Benincasa hispida, Bertholletia excelsea, Beta vulgaris, Brassica spp. (e.g., B. napus, B. rapa ssp. [canola, oilseed rape, turnip rape]), Cadaba farinosa, Camellia sinensis, Canna indica, Cannabis sativa, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., E. guineensis, E. oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g., G. max, Soja hispida or Soja max), Gossypium hirsutum, Helianthus spp. (e.g., H. annuus), Hemerocallis fulva, Hibiscus spp., Hordeum spp. (e.g., H. vulgare), Ipomoea batatas, Juglans spp., Lactuca sativa, Lathyrus spp., Lens culinaris, Linum usitatissimum, Litchi chinensis, Lotus spp., Luria aculangula, Lupinus spp., Luzula sylvatica, Lycopersicon spp. (e.g., L. esculentum, L. lycopersicum, L. pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., O. sativa, O. latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., S. tuberosum, S. integrifolium or S. lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., T. aestivum, T. durum, T. turgidum, T. hybernum, T. macha, T. sativum, T. monococcum or T. vulgare), Tropaeolum minus, Tropaeolum majus, Vaccinium spp., Vicia spp., Vigna spp., Viola odorata, Vitis spp., Zea mays, Zizania palustris, Ziziphus spp., amongst others.

Further examples of plants of interest include, but are not limited to, corn (Zea mays), Brassica sp. (e.g., B. napus, B. rapa, B. juncea), particularly those Brassica species useful as sources of seed oil, alfalfa (Medicago saliva), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Bela vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pukherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

Further plants of interest include Cannabis (e.g., sativa, indica, and ruderalis) and industrial hemp.

All plants and plant parts can be treated in accordance with the invention. In this context, plants are understood as meaning all plants and plant populations such as desired and undesired wild plants or crop plants (including naturally occurring crop plants). Crop plants can be plants that can be obtained by traditional breeding and optimization methods or by biotechnological and recombinant methods, or combinations of these methods, including the transgenic plants and the plant varieties.

Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

### EXAMPLES

It should be understood that the examples and embodiments described herein are for illustrative purposes only and that various modifications or changes in light thereof will be suggested to persons skilled in the art and are to be included within the spirit and purview of this application.

### Example 1—Fermentation of Pseudozyma aphidis for Mel Production in Portable 14 L Distributable Reactor

The working volume of the reactor is 10 liters. The reactor is a jacketed glass vessel with air spargers and a Rushton impeller. It is equipped with DO, pH, temperature, and foam probe. It has an integrated control station, built-in pumps, gas flow controllers, and pH/DO/foam level controllers.

The nutrient medium comprises sodium nitrate, potassium phosphate, magnesium sulfate, yeast extract, and vegetable oil. Inoculum can be a 1- to 2-day-old culture of Pseudozyma aphidis, at about 5-10% of the total culture volume. The cultivation duration is 9 to 15 days, and the final MEL production is 800 to 1,000 grams.

### Example 2—Evaluation of Nematode Attractant Efficacy

Counts and infestation percentages of Southern Root Knot Nematodes were taken in four 11.6 in.×7.6 in. sealed chambers containing lake fine sand soil spiked with an attractant material. Pre-made Valerian root extract was blended with water, vegetable glycerin and 20% grain alcohol to produce the attractant.

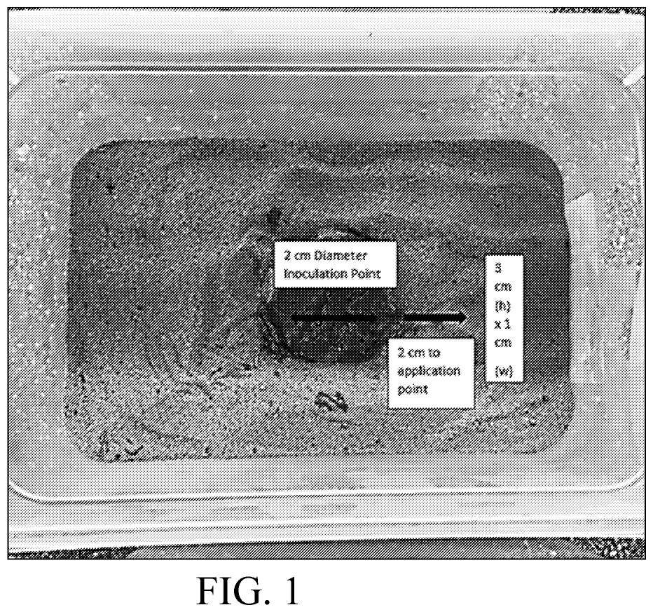

Each plot was inoculated with nematodes in a 2 cm diameter zone. 10 mL of the nematode attractant was added in a 3 cm (h)×1 cm (w) zone, 2 cm from the inoculation zone (FIG. 1).

Nematode counts and infestation percentages were taken in three locations, 3 days after treatment and 8 days after treatment. The three locations tested included the center of the inoculation zone, the attractant zone, and the untreated area.

### Results

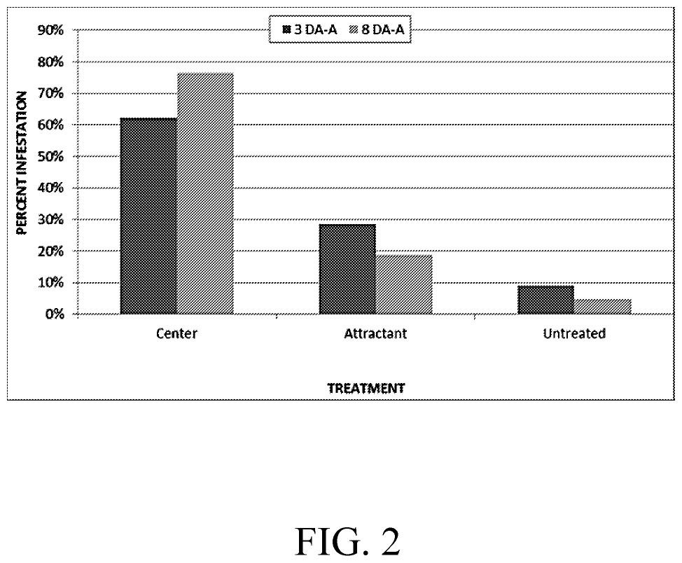

Results are summarized in FIG. 2. The migrations towards the attractant versus untreated area was significantly different relative to the inoculation area as a percentage of total population. At 24 and 48 hour sampling events, there were more nematodes counted in the attractant zone than the untreated areas of the chamber by more than 14%; however, the central zone where the nematodes were inoculated held the most nematodes overall.

1. A nematicidal composition comprising a chemo-attractant substance and a microbe-based composition, wherein the microbe-based composition comprises one or more beneficial microorganisms and/or growth by-products thereof, and wherein the one or more beneficial microorganisms and/or growth by-products thereof are capable of nematicidal action.

2. The nematicidal composition of claim 1, wherein the chemo-attractant substance comprises Valerian (Valeriana officinalis).

3-4. (canceled)

5. The nematicidal composition of claim 1, wherein the one or more beneficial microorganisms comprise Pleurotus ostreatus and/or a glycolipid-producing yeast.

6. The nematicidal composition of claim 1, wherein the one or more growth by-products comprises linoleic acid.

7. (canceled)

8. The nematicidal composition of claim 5, wherein the yeast is selected from Pseudozyma aphidis and Meyerozyma guilliermondii, and the glycolipid is a mannosylerythritol lipid (MEL).

9. The nematicidal composition of claim 1, wherein the one or more growth by-products is a mannosylerythritol lipid (MEL).

10. (canceled)

11. The nematicidal composition of claim 9, wherein the MEL is in the fowl of a supernatant resulting from cultivation of P. aphidis or M. guilliermondii.

12. The nematicidal composition of claim 1, wherein the one or more beneficial microorganisms comprise Streptomyces avermitilis and/or wherein the one or more growth by-products comprise avermectin.

13-15. (canceled)

16. The nematicidal composition of claim 1, comprising Valerian root extract, and one or more of the following:
live cells of P. ostreatus and/or growth by-products thereof,
live cells of S. avermitilis and/or growth by-products thereof, and
live cells of M. guilliermondii and/or growth by-products thereof.

17. A method for controlling nematodes present on a plant and/or in a plant's surrounding environment, the method comprising applying a chemo-attractant substance and a microbe-based composition to a locus,
wherein the microbe-based composition comprises one or more beneficial microorganisms and/or growth by-products thereof,
wherein the one or more beneficial microorganisms and/or growth by-products thereof are capable of nematicidal action, and
wherein the locus is within the plant's surrounding environment but located at a distance of at least 1 inch away from the plant.

18. The method of claim 17, wherein the chemo-attractant substance is Valerian root extract.

19. The method of claim 17, wherein the microbe based composition comprises one or more of the following:
live cells of P. ostreatus and/or growth by-products thereof,
live cells of S. avermitilis and/or growth by-products thereof, and
live cells of M. guilliermondii and/or growth by-products thereof.

20. The method of claim 19, wherein the growth by-products of P. ostreatus comprise linoleic acid in a purified form or in the form of a supernatant resulting from cultivation of P. ostreatus.

21. The method of claim 19, wherein the growth by-products of S. avermitilis comprise avermectin in a purified form or in the form of a supernatant resulting from cultivation of S. avermitilis.

22. The method of claim 19, wherein the growth by-products of M. guilliermondii comprise MEL in a purified form or in the form of a supernatant resulting from cultivation of M. guilliermondii.

23. The method of claim 17, wherein the plant's surrounding environment comprises soil or another medium in which the plant is growing, within a radius of 100 feet away from the plant.

24. (canceled)

25. The method of claim 17, used to control a nematode selected from root-knot nematode (Meloidogyne incognital), sting nematode (Belonolaimus longicaudatus), soybean cyst nematode (Heterodera glycines), lesion nematode (Pratylenchus sp.), dagger nematode (Xiphinema sp.), and citrus nematode (Tylenchulus semipenetrans).

26-29. (canceled)

30. The method of claim 17, wherein the chemo-attractant substance and/or the microbe-based composition are placed into a ground spike or bait station, and the ground spike or bait station is placed into soil at the locus.

31. (canceled)
